(19) United States
(12) Patent Application Publication
(10) Pub. No.: US 2025/0323469 A1
(43) Pub. Date: Oct. 16, 2025

(54) MULTI-CLAD SIGNAL FIBER FOR PUMP-SIGNAL COMBINER

(71) Applicant: Lumentum Operations LLC, San Jose, CA (US)

(72) Inventors: Gongwen ZHU, San Jose, CA (US); Guan SUN, San Jose, CA (US); Richard D. FAULHABER, San Carlos, CA (US)

(21) Appl. No.: 18/751,639

(22) Filed: Jun. 24, 2024

Related U.S. Application Data
(60) Provisional application No. 63/634,576, filed on Apr. 16, 2024.

(51) Int. Cl. H01S 3/094

(52) U.S. Cl. CPC H01S 3/094053

(57) ABSTRACT

In some implementations, a pump-signal fiber comprises a plurality of pump fibers configured to carry pump light and a signal fiber, surrounded by the plurality of pump fibers. In some implementations, the signal fiber comprises a core configured to carry signal light, a first cladding layer, surrounding the core, configured to confine the signal light within the core, and a second cladding layer, surrounding the first cladding layer.

### CROSS-REFERENCE TO RELATED APPLICATION

This patent application claims priority to U.S. Provisional Patent Application No. 63/634,576, filed on Apr. 16, 2024, and entitled “TRIPLE CLAD SIGNAL FIBER FOR PUMP AND SIGNAL COMBINER.” The disclosure of the prior application is considered part of and is incorporated by reference into this patent application.

### TECHNICAL FIELD

The present disclosure relates generally to an optical pump-signal combiner and to an optical pump-signal combiner that includes a central multi-clad signal fiber.

### BACKGROUND

Pump-signal combiners are critical components of high-power fiber lasers. A pump-signal combiner combines pump light and signal light to increase a power of the signal light.

### SUMMARY

In some implementations, a pump-signal combiner includes a plurality of pump fibers configured to carry pump light; and a signal fiber, surrounded by the plurality of pump fibers, including: a core configured to carry signal light; a first cladding layer, surrounding the core, configured to confine the signal light within the core; and a second cladding layer, surrounding the first cladding layer.

In some implementations, an optical system includes a plurality of light sources configured to generate pump light and signal light; an output fiber comprising a core surrounded by a cladding; and a pump-signal combiner coupled between the plurality of light sources and the output fiber, wherein the pump-signal combiner comprises: a plurality of pump fibers configured to couple the pump light into the cladding of the output fiber; and a signal fiber, surrounded by the plurality of pump fibers, comprising: a core configured to couple the signal light into the core of the output fiber; a first cladding layer, surrounding the core, configured to confine the signal light within the core; and a second cladding layer, surrounding the first cladding layer.

In some implementations, a method for manufacturing a pump-signal combiner includes forming a fiber bundle that comprises a plurality of pump fibers and a signal fiber, surrounded by the plurality of pump fibers, wherein the signal fiber comprises: a core; a first cladding layer, surrounding the core; and a second cladding layer, surrounding the first cladding layer; tapering the fiber bundle such that the fiber bundle has a profile that approximates a single central fiber at a taper waist; and attaching the tapered fiber bundle to an output fiber such that the plurality of pump fibers are optically coupled, at the taper waist, to a cladding of the output fiber and the core of the signal fiber is optically coupled, at the taper waist, to a core of the output fiber.

### BRIEF DESCRIPTION OF THE DRAWINGS

FIG. 1 is a diagram illustrating an example of a fiber merging device, such as a pump-signal combiner, and a process for manufacturing the fiber merging device.

FIG. 2 is a diagram illustrating example cross-sectional views of a double clad signal fiber and a pump-signal combiner that includes a double clad signal fiber.

FIG. 3 is a diagram illustrating example cross-sectional views of a multi-clad signal fiber and a pump-signal combiner that includes a multi-clad signal fiber.

FIG. 4 is a diagram illustrating an example of an optical system that includes one or more pump-signal combiners with a multi-clad signal fiber.

FIG. 5 is a flowchart of an example process for manufacturing a pump-signal combiner with a multi-clad signal fiber.

### DETAILED DESCRIPTION

The following detailed description of example implementations refers to the accompanying drawings. The same reference numbers in different drawings may identify the same or similar elements.

Pump-signal combiners are critical components of high-power fiber lasers. For example, a pump-signal combiner generally combines pump light to create combined pump light with an increased power. In many cases, pump combiners are arranged in a fiber bundle configuration, which is spliced to another optical structure (e.g., a master oscillator power amplifier (MOPA) and/or a single pass fiber laser structure) that is configured to deliver many hundreds of watts (W) or kilowatts (kW) of pump power. A fiber bundle configuration can be achieved by arranging pump fibers into a particular close-packed configuration (e.g., a hexagonal, octagonal, or other suitable close-packing configuration), and fusing and tapering individual pump fibers into a bundle of a target size. Furthermore, in a pump-signal combiner, a signal fiber is included with the individual pump fibers in the bundle. In this way, the various pump fibers can be used to couple pump power from multiple pump sources into a cladding of an output fiber, and signal light can propagate through a core of the signal fiber included in the pump-signal combiner and into a core of the output fiber. However, one challenge that arises in designing and fabricating pump-signal combiners is that the core of the signal fiber may be deformed during the tapering process. For example, a pump-signal combiner is typically made using a double clad fiber as a signal fiber, where an outer (second) cladding layer is removed prior to the forming the fiber bundle that is then fused and tapered. As a result, during the tapering process, the pump fibers that surround the signal fiber may compress the central signal fiber and deform the cladding layer surrounding the core. Furthermore, because the core typically has a lower softening temperature than the surrounding cladding layer, the deformation may be transferred to the core, resulting in signal degradation in the core.

In some implementations, as described herein, a pump-signal combiner may comprise a plurality of pump fibers configured to receive pump light and to transmit the pump light into a cladding of an output fiber, and a central signal fiber, surrounded by the plurality of pump fibers, that may be made from a multi-clad fiber. For example, as described herein, the multi-clad fiber may comprise a core, a first cladding layer surrounding the core, and a second cladding layer surrounding the first cladding layer. Accordingly, when a fiber bundle that includes the central signal fiber and the plurality of pump fibers is fused and tapered, the second cladding layer largely absorbs the deformation resulting from the pressure that occurs when the pump fibers are compressed around the signal fiber. For example, in some implementations, the second cladding layer may be made from a material that has a lower softening temperature than the first cladding layer, which results in the second cladding layer being deformed (e.g., into a polygram) during the fusing and tapering process. In this way, forming a pump-signal combiner from a fiber bundle that includes a signal fiber with two cladding layers may maintain a substantially circular profile for the first cladding layer and the core of the signal fiber, which preserves signal brightness. Furthermore, in some implementations, the second cladding layer of the signal fiber may be made from a different material than the pump fibers, which may reduce deformation of the pump fibers and thereby reduce degradation of the pump light carried in the pump fibers.

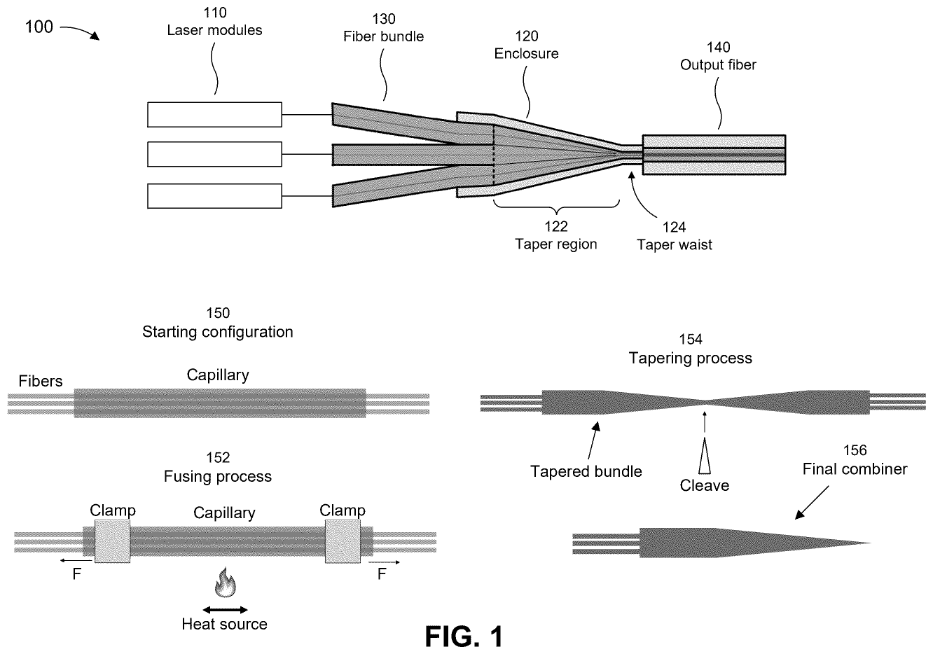

FIG. 1 is a diagram illustrating an example 100 of a fiber merging device, such as a pump-signal combiner, and a process for manufacturing the fiber merging device. For example, as shown in FIG. 1 and described herein, light emitted by multiple laser modules 110 may be combined via a fiber optic combiner to achieve a greater total system power than the laser modules 110 can achieve individually. For example, a fiber bundle 130 may include a plurality of pump fibers that are arranged or configured to receive pump light from respective pump sources (e.g., laser diodes included among the laser modules 110), with the plurality of pump fibers packed around a central signal fiber arranged or configured to receive signal light from a signal light source (e.g., a laser light source included among the laser modules 110). In some implementations, the signal light may generally propagate to the signal fiber included in the pump-signal combiner via an input signal fiber of an input component (e.g., an oscillator, an amplifier, a mode field adapter (MFA), or another suitable optical component). As used herein, the term “pump fiber” refers to any suitable fiber intended and optimally selected to carry pump light (e.g., an optical power source), and the term “signal fiber” refers to any suitable fiber intended and optimally selected to carry optical signal light.

After the plurality of pump fibers and the signal fiber are packed within the fiber bundle 130, the various fibers forming the fiber bundle 130 may be inserted into a glass enclosure 120 (e.g., a capillary) that is then etched and/or tapered to achieve a target initial diameter (e.g., until the cores of the fibers in the fiber bundle 130 are size-matched to an output fiber 140, within a threshold tolerance, such as 1% or 2% or another suitable value). For example, a section of the glass enclosure 120 may be heated until the glass or other material forming the enclosure 120 is soft and pliable, and the heated section of the enclosure 120 is then stretched to form a taper region 122 that gradually merges all of the fibers in the fiber bundle 130 into a profile that approximates a single central fiber. Alternatively, in some implementations, a pump-signal combiner may have a design without a glass enclosure 120. In such designs, rather than feeding the fiber bundle 130 that includes the pump fibers and the signal fiber into a glass enclosure 120, and then tapering the glass enclosure 120 to match the core and cladding size of the output fiber 140, the pump fibers and the signal fiber forming the fiber bundle 130 may be twisted, tapered, fused, and spliced to the output fiber 140 (e.g., such that the signal fiber transmits signal light into the core of the output fiber 140 and the pump fibers transmit pump light into the cladding of the output fiber 140). The fibers that are fused in the fiber bundle 130 may then be cleaved at a taper waist 124 (e.g., a location where a diameter of the enclosure 120 or the fused fiber bundle 130 is at a minimum), and the fused and tapered fiber bundle 130 may then be spliced to the output fiber 140. For example, the narrow end of the taper region 122 (e.g., the taper waist 124) may be optically attached (e.g., fusion spliced) to the output fiber 140. For example, in a pump-signal combiner, the narrow end of the taper region 122 may be optically attached to the output fiber 140 such that the signal fiber optically couples to a core of the output fiber 140 and the pump fibers optically couple to a primary cladding of the output fiber 140.

In some implementations, reference numbers 150-156 illustrate an example process for manufacturing a pump-signal combiner using a capillary structure (e.g., a glass enclosure with a circular or substantially circular inner periphery), although a pump-signal combiner may be made without a capillary or other enclosing structure. For example, reference number 150 corresponds to a starting structure or configuration for an N+1:1 combiner, which refers to a combiner that merges N pump fibers and one signal fiber. Furthermore, reference number 156 depicts a final configuration of the pump-signal combiner, where the various pump fibers and the signal fiber are fused such that the combined fibers can be spliced to one output fiber 140. For example, as shown by reference number 152, the capillary structure may be clamped at an input end and clamped at an output end after the various fibers forming the fiber bundle have been suitably loaded into the capillary structure. As further shown by reference number 152, a heat source may be applied to the capillary structure to taper the fiber bundle, where the heat source may move along a longitudinal axis of the capillary structure between the clamp at the input end and the clamp at the output end. Applying heat to the capillary structure may cause a glass material (e.g., fused silica or the like) forming the capillary structure to soften such that the glass material can be stretched and tapered, which causes the various fibers in the fiber bundle to be fused toward an output end of the combiner. As shown by reference number 154, the tapered fiber bundle may then be cleaved at a waist (e.g., a location where the fiber bundle has a minimum diameter), resulting in the final configuration shown by reference number 156.

As described herein, the term “fused silica” refers to the material properties of bulk silica material from which one or more fibers are composed (e.g., amorphous domains of silica are “fused” on a near-molecular level). Accordingly, the term “fused silica” is separate and independent from any descriptions provided herein that relate to fused fibers, which refers to a melding of the physical fiber structures at a much larger size scale during formation of a combiner from multiple fibers.

As indicated above, FIG. 1 is provided as an example. Other examples may differ from what is described with regard to FIG. 1.

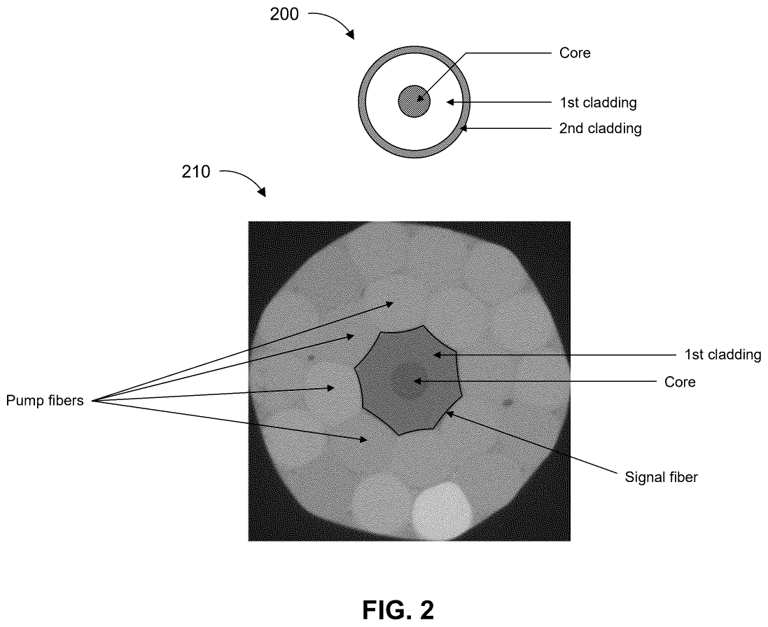

FIG. 2 is a diagram illustrating an example cross-sectional view 200 of a double clad signal fiber and an example cross-sectional view 210 a pump-signal combiner that uses a double clad fiber as a signal fiber. As described herein, a “double clad fiber” may refer to a fiber that includes a core, which is circumferentially surrounded by a first cladding layer, which is circumferentially surrounded by a second (outermost) cladding layer that is not present in a final pump-signal combiner. For example, optical fibers practically need, and are generally manufactured with, a protective polymer coating, which is the second (outermost) cladding layer in a double clad fiber. The protective polymer coating is generally incompatible with drawing and splicing processes used to fabricate a pump-signal fiber, and is therefore removed before the pump-signal combiner is fabricated and re-applied to the fused fiber bundle after completion. Accordingly, any references to a “double clad fiber” refer to the configuration prior to removal of the second cladding layer that provides the protective polymer coating (e.g., when used as a signal fiber in a pump-signal combiner, a double clad fiber has only one cladding layer in the final pump-signal combiner device).

As described herein, pump-signal combiners typically use a double clad fiber as a signal fiber. In some configurations, the signal fiber may be circumferentially surrounded by multiple pump fibers. For example, FIG. 2 illustrates a cross-sectional view 200 of an example double clad optical fiber that may be used as a signal fiber in a pump-signal fiber. As shown in FIG. 2, the double clad optical fiber includes a circular core circumferentially surrounded by a first (e.g., inner) cladding configured to confine the signal light within the core, with a second (e.g., outer) cladding surrounding the first cladding. In general, the core is configured to carry signal light, and the first cladding layer is configured to confine the signal light within the core (e.g., based on a refractive index difference between the material used for the core and the material used for the first cladding layer). However, when used in a pump-signal combiner, the core of the signal fiber may be deformed, which may result in high signal loss. For example, as described herein, one challenge that arises with using a double clad signal fiber in a pump-signal combiner is that the pump fibers may compress the signal fiber in the middle of the bundle during the tapering process. For example, as shown by the cross-sectional view 210, the first cladding layer surrounding the core of the signal fiber is compressed into a polygonal shape when the fiber bundle is heated and tapered. For example, in the illustrated configuration, where the signal fiber is surrounded by a ring of 8 pump fibers, the first cladding layer of the signal fiber is deformed into an octagonal shape. The core of the signal fiber is typically made from fused silica that is doped with germanium (Ge) or another suitable material, and the first cladding layer is typically made from undoped fused silica.

Accordingly, based on the materials that are typically used for the core and the first cladding layer of the signal fiber, the core usually has a lower softening temperature than the first cladding layer. For example, the softening temperature of a material generally refers to a temperature at which the material becomes soft and starts to flow under a given load, which may be measured using techniques such as the Vicat method (e.g., determining a temperature at which a needle or other instrument penetrates the material to a specific depth) and/or a ring-and-ball method, among other examples. More particularly, because the fiber bundle must be heated to a suitable temperature to stretch and taper the first cladding layer, the core of the signal fiber that has the lower softening temperature may generally be more pliable than the first cladding layer at the desired tapering temperature. Accordingly, when the pressure of the pump fibers compresses and deforms the first cladding layer, the deformation of the first cladding layer will be transferred to the core of the signal fiber, causing signal degradation in the core. Furthermore, the pump fibers surrounding the signal fiber may also experience degradation because the cores of the pump fibers and the first cladding layer of the signal fiber are often made from the same material (e.g., undoped fused silica). As a result, the cores of the pump fibers and the first cladding layer of the signal fiber may squeeze and deform each other, which results in higher degradation for both the pump light traveling in the pump fibers and the signal light traveling in the core of the signal fiber.

As indicated above, FIG. 2 is provided as an example. Other examples may differ from what is described with regard to FIG. 2.

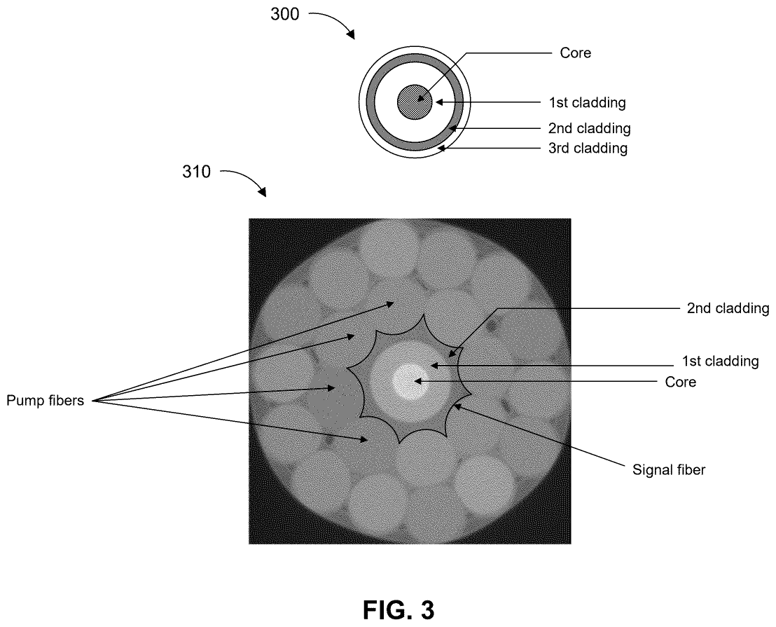

FIG. 3 is a diagram illustrating an example cross-sectional view 300 of a multi-clad signal fiber and an example cross-sectional view 310 of a pump-signal combiner that includes a multi-clad signal fiber. For example, as shown in cross-sectional view 300, the multi-clad fiber signal fiber may be based on a triple clad fiber that includes a core configured to carry signal light, a first cladding layer circumferentially surrounding the core to confine the signal light within the core, a second cladding layer circumferentially surrounding the first cladding layer, and an outermost protective layer circumferentially surrounding the second cladding layer. In some implementations, the core may be made from doped fused silica (e.g., Ge-doped fused silica, although dopants other than germanium may be used), the first cladding layer may be made from pure (undoped) silica, and the second cladding layer may be made from doped fused silica (e.g., fused silica that has been doped with fluorine (F), boron (B), phosphorus (P), or another suitable dopant). Furthermore, the triple clad fiber may include a third (outermost) coating layer made from a low index polymer or a high index polymer coating that is removed before packing the fiber into a fiber bundle.

In some implementations, as described herein, the second cladding layer is made from a material (e.g., doped fused silica) that has a lower softening temperature than the first cladding layer (e.g., pure fused silica). Accordingly, the second (e.g., middle) cladding layer is softer than the first cladding layer at a drawing temperature, which refers to a temperature to which the fiber bundle is heated when being fused and tapered. As a result, the second cladding layer largely absorbs a significant portion of the deformation stresses that occur when the fiber bundle is heated, fused, stretched, and tapered, thereby protecting the core of the signal fiber and reducing signal loss (e.g., power loss and/or a beam parameter product (BPP) loss), preserving signal brightness, and/or reducing degradation of the pump light in the pump fibers.

Accordingly, as shown in cross-sectional view 310, a pump-signal combiner may include a multi-clad signal fiber surrounded by multiple pump fibers, where the multi-clad signal fiber is made from the triple clad fiber shown in cross-sectional view 300. When used in a pump-signal combiner, the third (outer) cladding layer is removed from the triple clad signal fiber, which is then packed into a fiber bundle with multiple pump fibers surrounding the signal fiber and tapered in the manner described above with reference to FIG. 1. The protective polymer coating or outer cladding layer may then be reapplied after the tapered bundle is spliced to an output fiber. As described herein, because the second cladding is made from a material (e.g., doped fused silica) that has a lower softening temperature than the material used in the first cladding (e.g., pure fused silica), the second cladding layer can largely absorb the deformation that occurs during tapering and mitigate deformation of the first cladding layer of the signal fiber, the core of the signal fiber, and the plurality of pump fibers. For example, as shown in cross-sectional view 310, the second cladding layer is deformed from a round shape to a polygram (e.g., an octagram based on the inner ring of pump fibers including 8 pump fibers), where the second cladding layer has a substantially circular inner profile and a substantially polygonal outer profile. Furthermore, because the first cladding layer is harder than the second cladding layer at the drawing temperature, the first cladding layer that surrounds the core retains a substantially circular inner profile and a substantially circular outer profile, exhibiting minimal deformation and transferring minimal to no deformation to the core of the signal fiber. In this way, the core is protected against deformation and brightness, power, and/or quality of the signal light traveling in the core is preserved. Furthermore, the pump fibers surrounding the signal fiber may exhibit less degradation than a pump-signal combiner that uses a double clad fiber as a signal fiber because the (e.g., fluorine-doped) second cladding layer acts as a buffer between the pump fibers and the signal fiber. For example, the pump fibers may be made from pure (undoped) fused silica, and may therefore resist deformation during the tapering process in a similar manner as the first cladding layer that is made from pure fused silica. In this way, the pump fibers also retain substantially circular inner and outer profiles, which reduces degradation of the pump light traveling in the pump fibers.

As indicated above, FIG. 3 is provided as an example. Other examples may differ from what is described with regard to FIG. 3.

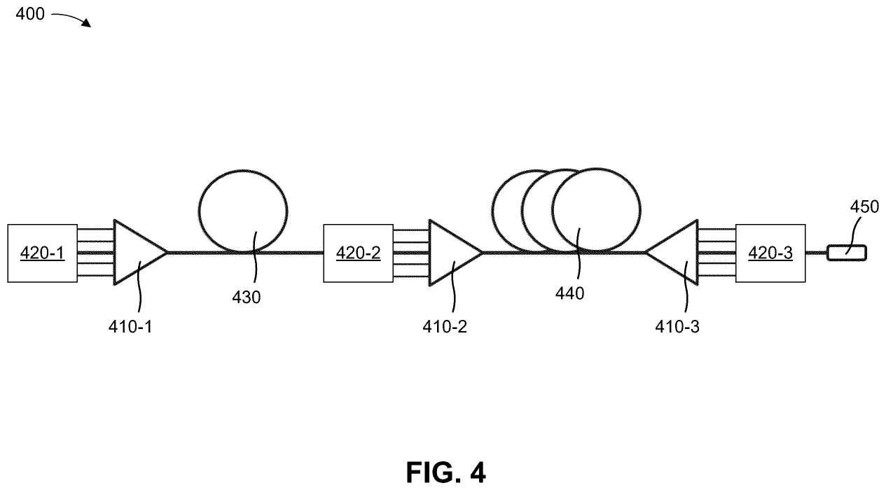

FIG. 4 is a diagram illustrating an example of an optical system 400 that includes one or more pump-signal combiners 410 with a multi-clad signal fiber (e.g., a pump-signal combiner that includes a plurality of pump fibers surrounding a central signal fiber with a core, a first cladding layer surrounding the core, and a second cladding layer that surrounds the first cladding layer to absorb deformation that occurs during a tapering process to preserve a circular profile for the first cladding layer, as described herein with respect to FIG. 3). As further shown in FIG. 4, the optical system 400 may include one or more sets of light sources 420, an oscillator 430, one or more amplifiers 440, and/or a laser output 450. In some implementations, the optical system 400 is associated with a MOPA configuration. However, a pump-signal combiner with a multi-clad signal fiber may be used for various other applications, such as a fiber amplifier, a fiber laser, and/or a wavelength-division multiplexing system, among other examples.

As shown in FIG. 4, a first set of light sources 420-1 (e.g., corresponding to a first input subsystem) may include one or more light sources configured to provide signal light and a plurality of light sources configured to provide pump light. In some implementations, the signal light and the pump light generated by the first set of light sources 420-1 is provided to a first pump-signal combiner 410-1 arranged between the first set of light sources 420-1 and an output fiber in an end pumping or forward pumping configuration. For example, as described herein, the output fiber may include one or more cores configured to carry the signal light and a cladding layer, surrounding the core, configured to carry the pump light. Accordingly, the first pump-signal combiner 410-1 may combine the signal light and the pump light provided by the first set of light sources 420-1 to form a first combined signal beam.

In some implementations, the first pump-signal combiner 410-1 may provide the first combined signal beam to the oscillator 430, which may provide the first combined signal beam to a second pump-signal combiner 410-2 (e.g., arranged in a cascaded pumping configuration in the illustrated example). For example, as shown in FIG. 4, a second set of light sources 420-2 may be configured to provide pump light to the second pump-signal combiner 410-2, which may combine the first combined signal beam and the pump light generated by the second set of light sources 420-2 to form a second combined signal beam. The second pump-signal combiner 410-2 may provide the second combined signal beam to the one or more amplifiers 440, which may amplify the second combined beam and provide the second combined signal beam to a third pump-signal combiner 410-3 (e.g., that is arranged in a counter pumping or backward pumping configuration in the illustrated example). For example, as shown in FIG. 4, a third set of light sources 420-3 may be configured to generate pump light (e.g., that propagates in an opposite direction of a propagation direction of the second combined signal beam) to the third pump-signal combiner 410-3, which may combine the second combined signal beam and the pump light generated by the third set of light sources 420-3 to form a third combined signal beam that may be provided to the laser output 450 (e.g., that may emit the third combined signal beam toward a target of the optical system 400).

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

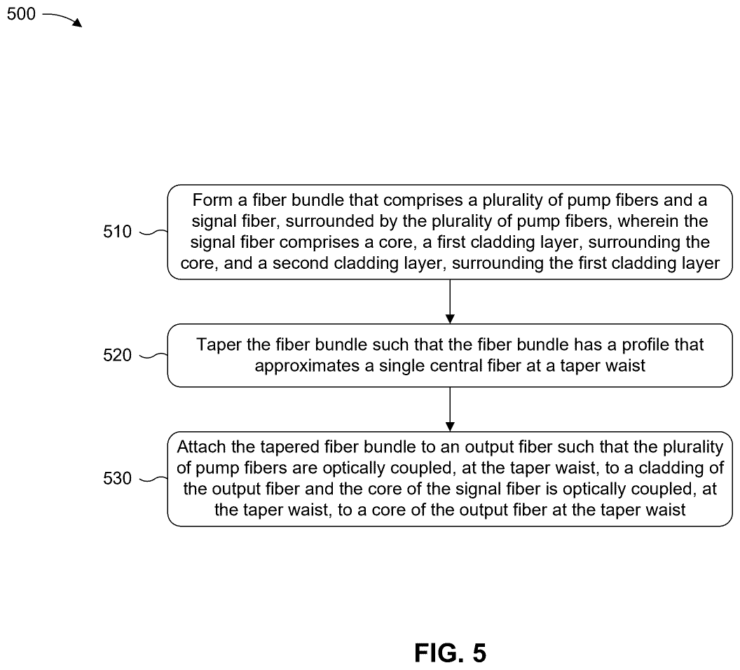

FIG. 5 is a flowchart of an example process 500 for manufacturing a pump-signal combiner with a multi-clad signal fiber. In some implementations, one or more process blocks of FIG. 5 may be performed by various manufacturing equipment.

As shown in FIG. 5, process 500 may include forming a fiber bundle that comprises a plurality of pump fibers and a signal fiber, surrounded by the plurality of pump fibers, wherein the signal fiber comprises: a core; a first cladding layer, surrounding the core; and a second cladding layer, surrounding the first cladding layer (block 510). As further shown in FIG. 5, process 500 may include tapering the fiber bundle such that the fiber bundle has a profile that approximates a single central fiber at a taper waist (block 520). As further shown in FIG. 5, process 500 may include attaching the tapered fiber bundle to an output fiber such that the plurality of pump fibers are optically coupled, at the taper waist, to a cladding of the output fiber and the core of the signal fiber is optically coupled, at the taper waist, to a core of the output fiber (block 530).

Process 500 may include additional implementations, such as any single implementations or any combination of implementations described below and/or in connection with one or more other implementations described elsewhere herein.

In a first implementation, the second cladding layer of the signal fiber is made from doped fused silica.

In a second implementation, alone or in combination with the first implementation, the first cladding layer of the signal fiber is made from undoped fused silica.

In a third implementation, alone or in combination with one or more of the first and second implementations, the second cladding layer of the signal fiber has a lower softening temperature than the first cladding layer.

In a fourth implementation, alone or in combination with one or more of the first through third implementations, the first cladding layer of the signal fiber has a substantially circular inner profile and a substantially circular outer profile at a taper waist of the pump-signal fiber.

In a fifth implementation, alone or in combination with one or more of the first through fourth implementations, the plurality of pump fibers and the second cladding layer of the signal fiber are made from different materials.

In a sixth implementation, alone or in combination with one or more of the first through fifth implementations, the second cladding layer of the signal fiber has a substantially circular inner profile and a substantially polygonal outer profile at a taper waist of the pump-signal fiber.

Although FIG. 5 shows example blocks of process 500, in some implementations, process 500 may include additional blocks, fewer blocks, different blocks, or differently arranged blocks than those depicted in FIG. 5. In some implementations, process 500 may include forming the pump-signal combiner, an integrated assembly or optical system that includes the pump-signal combiner, any part described herein of the pump-signal combiner, and/or any part described herein of an integrated assembly or optical system that includes the pump-signal combiner.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A pump-signal combiner, comprising:
a plurality of pump fibers configured to carry pump light; and
a signal fiber, surrounded by the plurality of pump fibers, comprising:
a core configured to carry signal light;
a first cladding layer, surrounding the core, configured to confine the signal light within the core; and
a second cladding layer, surrounding the first cladding layer.

2. The pump-signal combiner of claim 1, wherein the second cladding layer of the signal fiber is made from doped fused silica.

3. The pump-signal combiner of claim 1, wherein the first cladding layer of the signal fiber is made from undoped fused silica.

4. The pump-signal combiner of claim 1, wherein the second cladding layer of the signal fiber has a lower softening temperature than the first cladding layer.

5. The pump-signal combiner of claim 1, wherein the first cladding layer of the signal fiber has a substantially circular inner profile and a substantially circular outer profile at a taper waist of the pump-signal fiber.

6. The pump-signal combiner of claim 1, wherein the plurality of pump fibers and the second cladding layer of the signal fiber are made from different materials.

7. The pump-signal combiner of claim 1, wherein the second cladding layer of the signal fiber has a substantially circular inner profile and a substantially polygonal outer profile at a taper waist of the pump-signal fiber.

8. An optical system, comprising:
a plurality of light sources configured to generate pump light and signal light;
an output fiber comprising a core surrounded by a cladding; and
a pump-signal combiner coupled between the plurality of light sources and the output fiber, wherein the pump-signal combiner comprises:
a plurality of pump fibers configured to couple the pump light into the cladding of the output fiber; and
a signal fiber, surrounded by the plurality of pump fibers, comprising:
a core configured to couple the signal light into the core of the output fiber;
a first cladding layer, surrounding the core, configured to confine the signal light within the core; and
a second cladding layer, surrounding the first cladding layer.

9. The optical system of claim 8, wherein the second cladding layer of the signal fiber is made from doped fused silica.

10. The optical system of claim 8, wherein the first cladding layer of the signal fiber is made from undoped fused silica.

11. The optical system of claim 8, wherein the second cladding layer of the signal fiber has a lower softening temperature than the first cladding layer.

12. The optical system of claim 8, wherein:
the first cladding layer of the signal fiber has a substantially circular inner profile and a substantially circular outer profile at a taper waist of the pump-signal fiber, and
the second cladding layer of the signal fiber has a substantially circular inner profile and a substantially polygonal outer profile at the taper waist of the pump-signal fiber.

13. The optical system of claim 8, wherein the plurality of pump fibers and the second cladding layer of the signal fiber are made from different materials.

14. A method for manufacturing a pump-signal combiner, comprising:
forming a fiber bundle that comprises a plurality of pump fibers and a signal fiber, surrounded by the plurality of pump fibers, wherein the signal fiber comprises:
a core;
a first cladding layer, surrounding the core; and
a second cladding layer, surrounding the first cladding layer;
tapering the fiber bundle such that the fiber bundle has a profile that approximates a single central fiber at a taper waist; and
attaching the tapered fiber bundle to an output fiber such that the plurality of pump fibers are optically coupled, at the taper waist, to a cladding of the output fiber and the core of the signal fiber is optically coupled, at the taper waist, to a core of the output fiber.

15. The method of claim 14, wherein the second cladding layer of the signal fiber is made from doped fused silica.

16. The method of claim 14, wherein the first cladding layer of the signal fiber is made from undoped fused silica.

17. The method of claim 14, wherein the second cladding layer of the signal fiber has a lower softening temperature than the first cladding layer.

18. The method of claim 14, wherein the first cladding layer of the signal fiber has a substantially circular inner profile and a substantially circular outer profile at a taper waist of the pump-signal fiber.

19. The method of claim 14, wherein the plurality of pump fibers and the second cladding layer of the signal fiber are made from different materials.

20. The method of claim 14, wherein the second cladding layer of the signal fiber has a substantially circular inner profile and a substantially polygonal outer profile at a taper waist of the pump-signal fiber.
